(19) United States
(12) Patent Application Publication
(10) Pub. No.: US 2011/0290399 A1
(43) Pub. Date: Dec. 1, 2011

(54) Quilt boards for no sew quilting

(76) Inventor: Karen Maree Raum, Erie, CO (US)

(21) Appl. No.: 13/068,752

(22) Filed: May 19, 2011

Related U.S. Application Data
(60) Provisional application No. 61/396,548, filed on May 28, 2010.

(51) Int. Cl. B32B 37/12; B32B 27/00; B26D 5/08; B32B 9/00; B32B 38/00; B23P 11/00

(52) U.S. Cl. 156/60; 29/428; 83/523; 428/318.4; 428/319.3

(57) ABSTRACT

The design and method for no sew fabric quilting is described that produces quilt like pictures for home decor or other uses. A pliable or foam like material serves as the quilting medium to which fabric is attached by tucking the fabric into cut pattern grooves. A thin rigid base provides support to the quilt picture. An adhesive coating with a paper carrier is part of the cut pattern medium and provides added support to the cut grooves in holding fabric in place. The paper carrier, when peeled off the adhesive also serves as a pattern piece to cut the fabric. Fabric is placed on the adhesive and edges tucked into pattern grooves using a narrow scalpel like tool. A thin foam sheet attached to the base backside finishes the item and is then ready to be hung after adding a wall hanger.

### CROSS-REFERENCE TO RELATED APPLICATIONS

I am claiming benefit of the provisional application 61/396,548 dated May 28, 2010.

### STATEMENT REGARDING FEDERALLY SPONSORED RESEARCH OR DEVELOPMENT

This invention was not the result of any federally sponsored research.

### REFERENCE TO SEQUENCE LISTING, A TABLE, OR A COMPUTER PROGRAM LISTING COMPACT DISK APPENDIX

Not applicable.

### BACKGROUND OF THE INVENTION

1. Field of the Invention

The present invention relates to the field of quilting and is a tool/medium that allows the crafts person to produce a quilted look fabric picture without the need for sewing.

2. Description of the Related Art

The invention, referred to as a no sew quilt board, is a no sew means of quilting a fabric pattern or picture for home decor or other display purposes. Fabric in this case can be a cloth or paper media. Quilt boards are an easy way to create beautiful fabric quilt like pictures with less time invested, can be made while watching television, or riding in a car. Sewing equipment, typically used in quilting, is not required in this method of quilting. This invention is an easy to use, more robust, and durable when compared to other attempts at no sew quilting. The conventional art of quilting requires the laborious task of hand sewing or the use of expensive, bulky sewing machines. The no sew quilt board eliminates the tedious sewing and bulky machines while still creating beautiful quilt like pictures with the use of only a few small tools and light weight compact materials. Other methods to produce no sew quilting have been identified such as in U.S. Pat. No. 5,226,468, where use of a separate fabric gripper is required. This additional complexity in the current art is done away with using the invention described herein.

### BRIEF SUMMARY OF THE INVENTION

A pattern is cut into a pliable material, such as foam, and serves as the medium to which the fabric (paper or other cloth like media) is attached, producing the quilt like picture. Additionally, the foam surface has an adhesive coating that also serves to capture and hold the fabric in place. The adhesive coating has a paper carrier. The foam is attached to a base, such as thin wood panel or plastic, giving the picture a rigid support frame. The paper carrier is taken off the adhesive a section at a time and is used as a pattern piece to cut the fabric. The fabric is cut slightly oversize (approx ⅛ in) from the paper pattern and the fabric is positioned on the adhesive. Using a narrow tool, such as a scalpel, the raw edges of the fabric are tucked down into the cut grooves in the foam. This combination of adhesive contact and tucking the fabric into the cut grooves is the no sew process of creating the quilt pattern. When the picture is complete with fabric applied to all sections, a soft backing such as foam or felt can attached to the back of the base to finish it and a picture hanger can then be attached. The finished item is then referred to as a quilt board and can be put on display. The quilt boards are of various sizes with 12 in×12 in and 6 in×6 in typical. Rectangular shapes are also possible. Typical thickness ranges from about ½ to 1 inch.

Utilizing the advantages of this design, the following objectives can be attained:

It is an objective of the present invention to provide beautiful no sew quilted like pictures for use in home decor.

It is also an objective of the invention to provide an easy to use quilting technique that can be enjoyed by the hobbyist.

It is also an objective of the invention to enable the creation of quilting pictures with out the need of sewing.

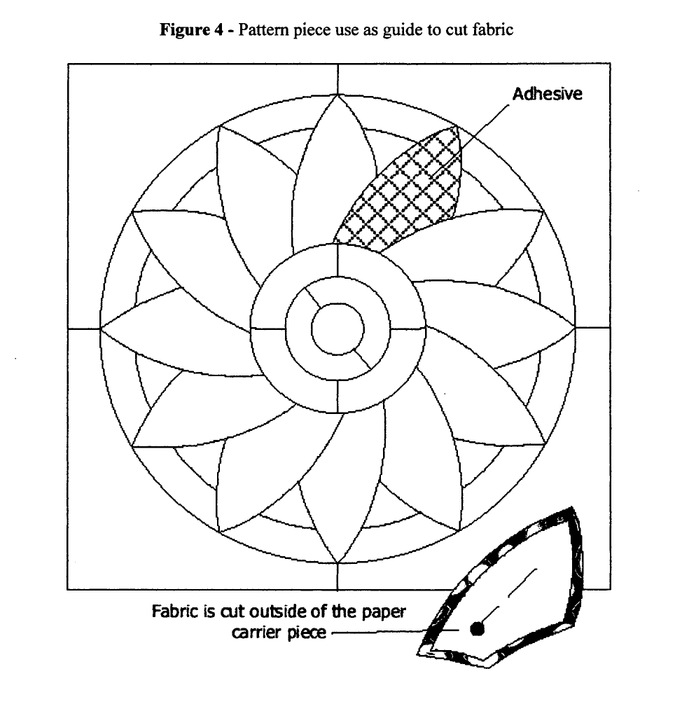

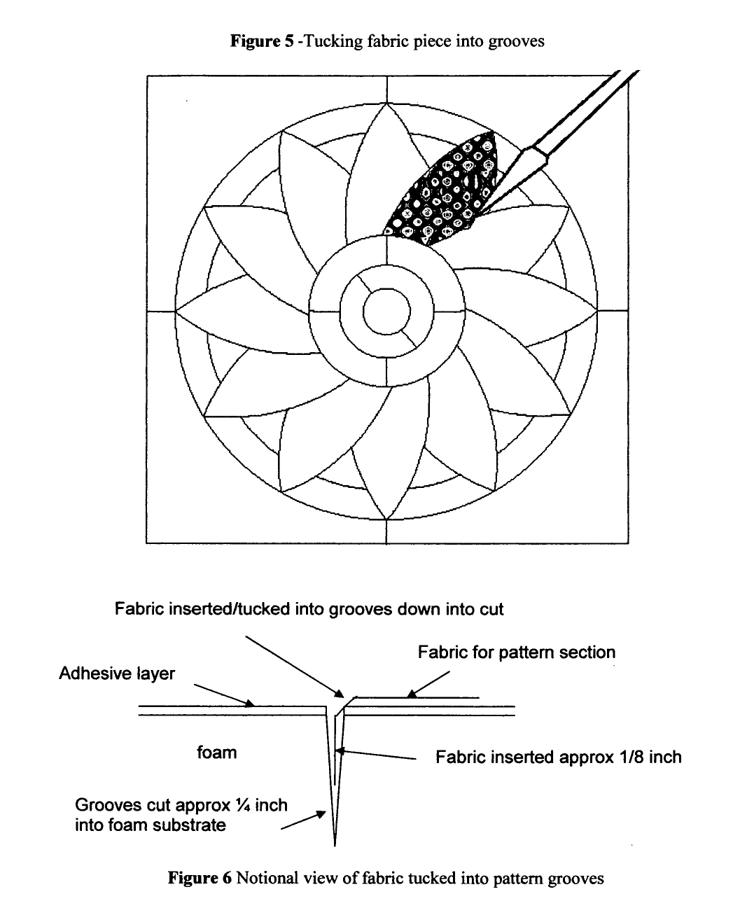

It is also an objective of the invention to provide a robust design for a no sew quilting technique. shape as described in FIG. 4 (SHEET 3/4). The fabric is cut oversize approximately ⅛″ from the pattern piece. After the fabric piece is placed on the adhesive (to conform to the shape), a narrow tool, such as a dull scalpel is used to tuck the raw edges of the fabric into the grooves of the quilting medium as shown in FIG. 5 (SHEET 4/4). A notional view of the fabric tucked into the groove and down into the cut is shown in FIG. 6. This process is repeated for each pattern section until fabric is applied to all pattern sections.

When fabric has been applied to all sections of the quilt board and the quilting complete, a soft backing can be applied to the back to finish the board. A picture hanger can then be attached for wall hanging.

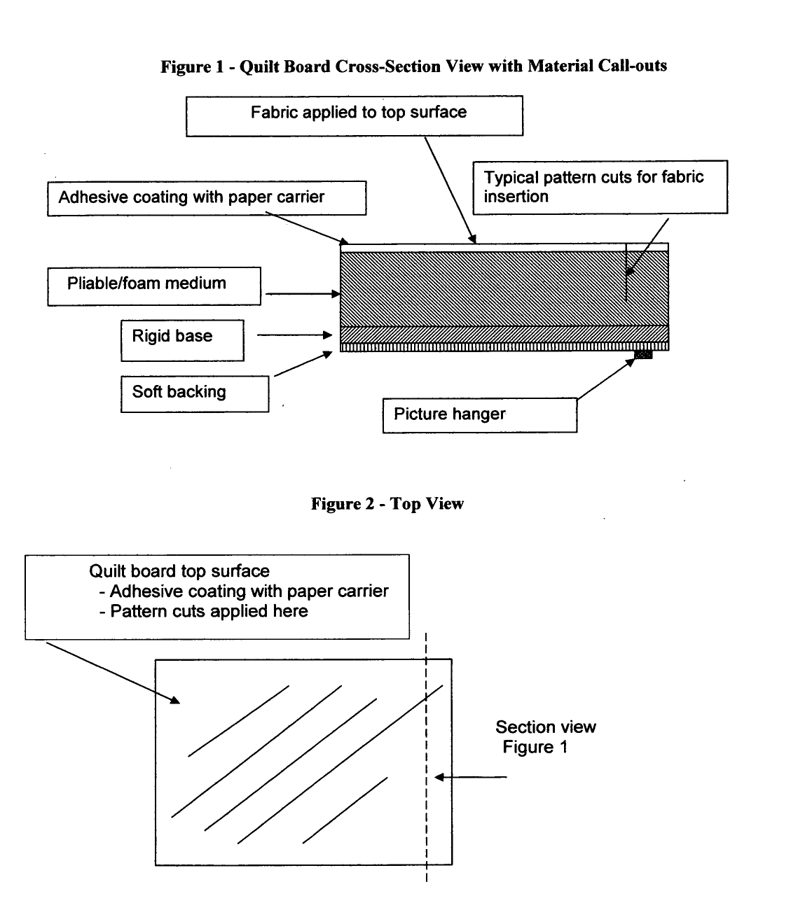

The following items comprise the makeup of the invention for use as a decorative item and are listed in top to bottom order as shown in the drawing SHEET 1/4 FIG. 1:

1. Adhesive coating with paper carrier

2. Approximately ½ inch pliable material or foam with precut pattern

3. Thin rigid base, such as wood or plastic panel

4. Backing such as foam or felt

5. Picture hanger

Items 1 through 3 are the essential part of the invention with 4 & 5 techniques for finishing it into decorative item for, display.

The section view in FIG. 1 SHEET 1/4 also provides a notional view of a groove/cut in the foam medium. Fabric is inserted into these cuts running along the edge of the pattern, which appear as pattern grooves on the top surface. The cut grooves pinch and hold the fabric in place producing a quilt like effect. This is further described in FIG. 6 SHEET 4/4

It is also an objective of the invention that in addition to the fabric held in place by being tucked into the cut grooves of the pattern, it is also held tightly in place via use of an adhesive coating.

It is also an objective of this invention to have the paper carrier sections of the adhesive coating to also serve as pattern pieces for the fabric.

It is also an objective of the invention to provide a thin lightweight rigid base for support for the quilted fabric picture.

### DRAWINGS

There are four sheets having five figures to describe the invention:

Drawing Sheet 1/4 showing FIGS. 1 & 2 that describe the design of no sew quilt board invention with cross section and top surface views.

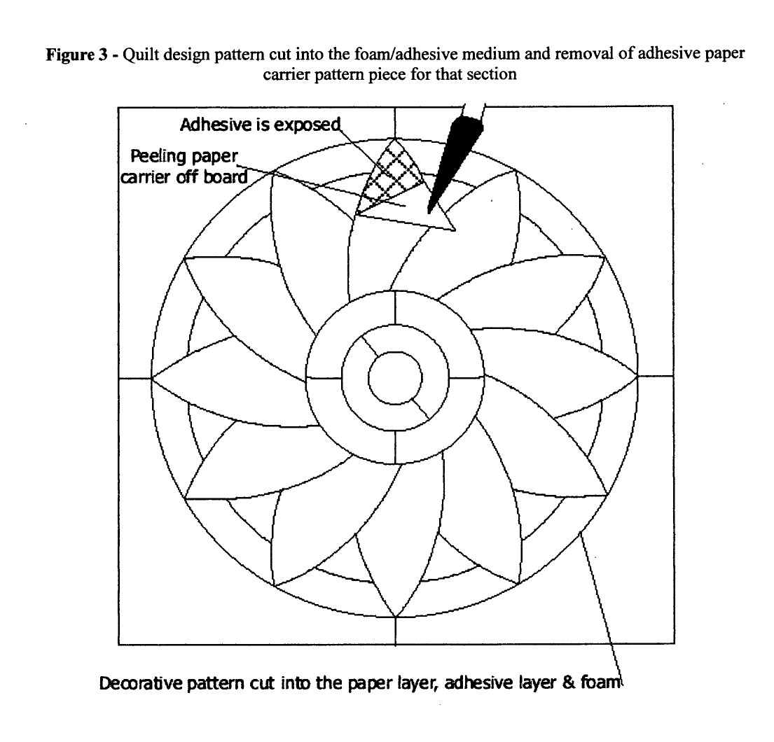

Drawing SHEET 2/4 shows FIG. 3 depicting a quilt design pattern cut into the foam/adhesive medium and removal of adhesive paper carrier to serve as a section pattern piece.

Drawing SHEET 3/4 shows FIG. 4 depicting how a pattern piece can serve as a guide to cut the fabric.

Drawing SHEET 4/4 with FIG. 5 depicting the fabric piece being tucked into the cut pattern grooves and FIG. 6 a notional view of the groove/cut and tucked fabric

### DETAILED DESCRIPTION OF THE INVENTION

The present invention consists of the quilting medium with a precut pattern and a rigid base. The use of soft backing and hanger are techniques to finish it. The quilting medium is foam or other pliable material that is attached to a rigid base panel, and then an adhesive layer with a paper carrier is placed over the foam/pliable medium. The drawing in FIGS. 1 and 2 (SHEET 1) depicts the configuration in top and cross section view. The quilt pattern is cut by a laser or other means through the adhesive with paper carrier and partway down into the foam medium. The foam is a polystyrene or similar material. Fabric is applied to create the quilted picture by first peeling off the paper carrier from the adhesive in the cut sections (one at a time), as shown in FIG. 3 (SHEET 2). The peeled off paper from the cut section can be used as a pattern piece to cut the fabric to the proper

What is claimed:

1. A method to produce a quilt look decorative item without the need for sewing.

2. The method of claim 1 that attaches and joins fabric, paper, or other cloth like media to a substrate.

3. The method of claim 2, wherein the substrate or medium is comprised of foam covered with an adhesive layer to attach and join fabric along grooves that are cut into it.

4. The method of claim 3 wherein tucking the fabric into the cut pattern grooves secures the fabric in place producing a quilt like effect.

5. The method of claim 3 wherein the adhesive layer holds the fabric in place while tucking the edges into the grooves as well as holding the fabric tightly against the top surface.

6. The method of claim 3 wherein the pattern grooves are cuts that go into the foam medium that pinch and hold the fabric after inserting it with a dull scalpel like tool.

7. A method utilizing a paper carrier of the adhesive when removed (exposing the adhesive for a pattern section), serves as a paper pattern piece for cutting the fabric to the required shape.

8. The method of claim 7 wherein the fabric is cut approximately ⅛ inch outside the paper pattern piece, producing the additional material needed to tuck into the foam grooves.

9. The method of claim 7 wherein the adhesive layer allows ease of placement and centering of the fabric on each pattern section.

10. A method utilizing a thin board or panel attached to the foam to provide a lightweight rigid base for support of the quilted fabric picture.
